(19) United States
(12) Patent Application Publication
(10) Pub. No.: US 2007/0078220 A1
(43) Pub. Date: Apr. 5, 2007

(54) Light-scattering plastics composition having high brightness and use thereof in flat screens

(75) Inventors: Heinz Pudleiner, Krefeld (DE); Klaus Meyer, Dormagen (DE); Jorg Nickel, Dormagen (DE); Claus Rudiger, Krefeld (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/542,267

(22) Filed: Oct. 3, 2006

(30) Foreign Application Priority Data
Oct. 5, 2005 (DE) 102005047614.7

(51) Int. Cl. C08L 51/00

(52) U.S. Cl. 525/67

(57) ABSTRACT

A thermoplastic composition suitable for making diffuser films is disclosed. The composition contains 90 to 99.95 percent of a transparent first polymeric resin and 0.01 to 10 percent particles of transparent second polymeric resin. The particles have a mean particle diameter of 1 to 100 μm and their refractive index differs from that of the first polymeric resin. Not more than 500 ppm of said particles have particle diameters in the range of 80 to 200 nm.

### FIELD OF THE INVENTION

The invention relates to a filled thermoplastic composition and more particularly to a composition suitable for making a diffuser film.

### BACKGROUND OF THE INVENTION

Light-scattering translucent products of transparent plastics materials having various light-scattering additives, and moldings produced therefrom, are already known from the prior art.

US 2004/0066645 A1 generally claims light-scattering materials comprising from 0.2 to 5% light-scattering particles, and the light transmission is greater than 70% and the haze is at least 10%.

The scattering additive has a mean diameter of from 3 to 10 μm.

JP 07-090167 claims a light-scattering plastics material that consists of from 1 to 10% particles having a refractive index of less than 1.5 and a particle size of from 1 to 50 μm, and from 90 to 99% of an aromatic polycarbonate, the particles being substantially insoluble in the aromatic polycarbonate.

As scattering additives there are used acrylate, polystyrene, glass, titanium dioxide or calcium carbonate particles.

LCDs are mentioned as an application.

EP 0 269 324 B1 describes the scattering additive composition containing 0.1 to 10% scattering additive.

The morphology of the core/shell acrylates and of the light-scattering compounds containing them is not described or characterised further.

In EP 0 634 445 B1, Paraloid EXL 5137 is used as a scattering additive in combination with from 0.001 to 0.3% of inorganic particles, for example titanium dioxide, inter alia in polycarbonate, contributing towards improved ageing resistance and hence color stability.

This advantage becomes important particularly when compounds having high contents of scattering agents (>2%) are exposed to elevated use temperatures (e.g. 140° C.) for a prolonged period (>500 hours).

JP 2004-053998 describes light-scattering polycarbonate films that have a thickness of from 30 to 200 μm and that consist of more than 90% polycarbonate, have a light transmission of more than 90%, have a concave-convex structure on at least one side of the film surface, have a haze of at least 50% and exhibit a retardation of less than 30 nm. A claimed application of these optical films is the use as diffuser films in backlight units.

In the application, diffuser films having low birefringence (retardation <30 nm, preferably <20 nm) are described and claimed, because they bring about higher brightness values in the BLU.

As scattering additives there are used from 1 to 10% inorganic particles, for example silicates, calcium carbonate or talcum, or organic particles, such as crosslinked acrylates or polystyrenes having a mean diameter of from 1 to 25 μm, preferably from 2 to 20 μm.

JP 08-146207 describes optical diffuser films in which the surface on at least one side has been structured by a shaping process. Also claimed is a film in which, when only one transparent scattering additive is used, that additive is distributed irregularly over the thickness of the film. If two or more scattering additives are used, they can be distributed uniformly over the thickness of the film.

In the case of irregular distribution of the scattering additive, concentration occurs at the film surface.

The scattering additives used can be acrylate, polyethylene, polypropylene, polystyrene, glass, aluminium oxide or silicon dioxide particles having a mean particle diameter of from 1 to 25 μm.

The films can have a thickness of from 100 to 500 μm.

JP 2004-272189 describes optical diffuser sheets having a thickness of from 0.3 to 3 mm, wherein scattering additives having a particle diameter of from 1 to 50 μm are used. It is further claimed that, within a brightness range of from 5000 to 6000 Cd/m², the differences in brightness are less than 3%.

WO 2004/090587 describes diffuser films having a thickness of from 20 to 200 μm for use in LCDs, which films comprise from 0.2 to 10% scattering additive and have a gloss of from 20 to 70% at least on one side. As scattering additives, which have a particle diameter of from 5 to 30 μm, crosslinked silicones, acrylates or talcum are incorporated by compounding.

In JP 06-123802 there are described diffuser films having a thickness of from 100 to 500 μm for LCDs, the difference in refractive index between the transparent base material and the transparent light-scattering particles being at least 0.05. One side of the film is smooth, while on the other side the scattering additives protrude from the surface and form the structured surface.

The scattering additives have a particle diameter of from 10 to 120 μm.

The diffuser films and sheets known from the prior art have unsatisfactory brightness, however, in particular in conjunction with the set of films conventionally used in a so-called backlight unit. In order to assess the suitability of the light-scattering sheets for so-called backlight units for LCD flat screens, the brightness of the system as a whole must be considered.

In principle, a backlight unit (direct light system) has the structure described below. It generally includes a housing in which, depending on the size of the backlight unit, a number of fluorescent tubes, so-called CCFLs (cold cathode fluorescent lamp), are arranged. The inside of the housing is equipped with a light-reflecting surface. The diffuser sheet, which has a thickness of from 1 to 3 mm, preferably a thickness of 2 mm, is disposed on this lighting system. On the diffuser sheet there is located a set of films, which may have the following functions: light scattering (diffuser films), circular polarizers, focusing of the light in the forward direction by so-called BEF (brightness enhancing film) and linear polarizers. The linear polarizing film is situated directly beneath the LCD display located above it

### SUMMARY OF THE INVENTION

A thermoplastic composition suitable for making diffuser films is disclosed. The composition contains 90 to 99.95 percent of a transparent first polymeric resin and 0.01 to 10 percent particles of transparent second polymeric resin. The particles have a mean particle diameter of 1 to 100 μm and their refractive index (optical density) differs from that of the first polymeric resin. Not more than 500 ppm of said particles have particle diameters in the range of 80 to 200 nm.

### DETAILED DESCRIPTION OF THE INVENTION

Light-scattering plastics compositions for optical applications conventionally comprise inorganic or organic particles having a diameter of from 1 to 50 micrometres, in some cases even up to 120 μm, i.e. -they contain scattering centres which are responsible for both the diffusive and the focusing properties.

There may be used as transparent scattering pigments in principle any acrylates that have sufficiently high thermal stability up to at least 300° C. that they are not destroyed at the processing temperatures of the transparent plastics material, preferably polycarbonate. In addition, pigments must not have any functionalities that lead to degradation of the polymer chain of the polycarbonate.

Suitable scattering pigments include acrylates, preferably having core/shell morphology such as the several grades within the Paraloid product line (Röhm & Haas) and Techpolymer (Sekisui).

Preference is given to the use of core-shell acrylates from the Paraloid group.

It has now been found, completely surprisingly, that plastics compositions that comprise conventional micrometer-sized particles, in particular so-called core-shell acrylates, and as few nano-scale particles as possible are suitable for backlight units on account of their brightness properties and their simultaneous high degree of light scattering. This effect is even more evident in conjunction with the set of films typically used in a backlight unit (BLU).

The art has thus far failed to recognize the formation or significance of a nano-scale phase characterizing the composition according to the invention.

In general, plastics compositions comprising light-scattering additives having mean particle sizes of less than 500 nm do not substantially affect the optical properties of films.

As has now, surprisingly, been found, very good brightness's of the backlight unit are obtained when the content of particles having a mean particle diameter of from 80 to 200 nm is less than 20 particles per 100 μm² surface area of the plastics composition, preferably less than 10 particles per 100 μm², particularly preferably less than 5 particles per 100 μm². The number of particles per surface area is determined by investigating the surface by means of atomic force microscopy (AFM). This method is known to the person skilled in the art and is described in greater detail in the examples. This means that the plastics composition comprises not more than 500 ppm, preferably less than 300 ppm, particularly preferably less than 100 ppm, of these nano-scale particles. The expression “ppm” here is in reference to the composition.

This invention accordingly provides plastics compositions that comprise transparent polymeric particles having a refractive index different from that of the matrix material and that are characterised by a content of nano-scale particles having a mean particle diameter of from 80 to 200 nm, wherein the content of nano-scale particles is less than 20 particles per 100 μm² surface area of the plastics composition, preferably less than 10 particles per 100 μm², particularly preferably less than 5 particles per 100 μm².

A preferred embodiment of the invention is a plastics composition that comprises 90 to 99.95 wt. % of a transparent plastics material, preferably polycarbonate, and 0.01 to 10 wt. % of polymeric transparent particles, these polymeric particles having a particle size of 1 to 50 μm, and up to 500 ppm of polymeric transparent particles having a particle size of from 80 to 200 nm.

This invention further provides a process for the preparation of the plastics composition according to the invention.

The plastics compositions according to the invention are preferably prepared and processed thermoplastically. The nano-scale polymeric particles are formed by shear during the thermoplastic processing. This mechanism of formation is shown by AFM investigations of extruded films. In order to verify the results, three samples were prepared per material and three locations in each case were tested for their morphology. Core/shell acrylates are preferred.

This invention relates also to the use of the plastics composition according to the invention for diffuser films (sheets) for flat screens, in particular in the backlighting of LCD displays.

The diffuser sheets produced from the plastics compositions according to the invention have high light transmission and high degree of light scattering, and they may be used, for example, in the lighting systems of flat screens (LCD screens), where a high degree of light scattering with, at the same time, high light transmission and focusing of the light in the direction towards the viewer is of critical importance. The lighting system of such flat screens may be effected either with lateral light input (edge light system) or, in the case of larger screen sizes, where lateral light input is not sufficient, by means of a backlight unit (BLU), in which the direct lighting behind the diffuser film must be distributed as uniformly as possible by the diffuser film (direct light system).

Suitable plastics materials for the plastics composition are any transparent thermoplastics: polyacrylates, polymethacrylates (PMMA; e.g. Plexiglas® from Röhm), cycloolefin copolymers (COC; e.g. Topas® from Ticona; Zenoex® from Nippon Zeon or Apel® from Japan Synthetic Rubber), polysulfones (Ultrason® from BASF or Udel® from Solvay), polyesters, for example PET or PEN, polycarbonate (e.g. Makrolon from Bayer MaterialScience AG), polycarbonate/polyester blends, e.g. PC/PET, polycarbonate/polycyclohexyl methanolcyclohexanedicarboxylate (PCCD; Sollx® from GE), polycarbonate/PBT (Xylex®).

Preference is given to the use of polycarbonates.

Suitable polycarbonates for the preparation of the plastics composition according to the invention are any known polycarbonates. These include homopoly-carbonates, copolycarbonates and thermoplastic polyester carbonates.

Suitable polycarbonates preferably have mean molecular weights M̅_{W} of from 18,000 to 40,000, preferably from 26,000 to 36,000 and especially from 28,000 to 35,000, determined by measuring the relative solution viscosity in dichloromethane or in mixtures of equal amounts by weight of phenol/o-dichlorobenzene calibrated by light scattering.

The preparation of the polycarbonates is preferably carried out by the interfacial process or the melt transesterification process and is described hereinbelow using the example of the interfacial process.

The polycarbonates are prepared, inter alia, by the interfacial process. This process for polycarbonate synthesis is described in the literature; e.g. H. Schnell, Chemistry and Physics of Polycarbonates, Polymer Reviews, Vol. 9, Interscience Publishers, New York 1964 p. 33 ff, Polymer Reviews, Vol. 10, “Condensation Polymers by Interfacial and Solution Methods”, Paul W. Morgan, Interscience Publishers, New York 1965, Chap. VIII, p. 325, Dres. U. Grigo, K. Kircher and P. -R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, p. 118-145, and EP-A 0 517 044.

Suitable diphenols are described, for example, in U.S. Pat. Nos. 2,999,835, 3,148,172, 2,991,273, 3,271,367, 4,982,014 and 2,999,846, in German Offenlegungsschriften 1 570 703, 2 063 050, 2 036 052, 2 211 956 and 3 832 396, French Patent Specification 1 561 518, in the monograph “H. Schnell, Chemistry and Physics of Polycarbonates, Interscience Publishers, New York 1964, p. 28ff; p. 102ff” and in “D. G. Legrand, J. T. Bendler, Handbook of Polycarbonate Science and Technology, Marcel Dekker New York 2000, p. 72ff”.

It is also possible to prepare polycarbonates from diaryl carbonates and diphenols according to the known polycarbonate process in the melt, the so-called melt transesterification process, which is described, for example, in WO-A 01/05866 and WO-A 01/05867. In addition, transesterification processes (acetate process and phenyl ester process) are described, for example, in U.S. Pat. Nos. 34,94,885, 43,86,186, 46,61,580, 46,80,371 and 46,80,372, in EP-A 26 120, 26 121, 26 684, 28 030, 39 845, 39 845, 91 602, 97 970, 79 075, 14 68 87, 15 61 03, 23 49 13 and 24 03 01 as well as in DE-A 14 95 626 and 22 32 977.

Both homopolycarbonates and copolycarbonates are suitable. For the preparation of copolycarbonates according to the invention as component A it is also possible to use from 1 to 25 wt. %, preferably from 2.5 to 25 wt. % (based on the total amount of diphenols to be used), of polydiorganosiloxanes having hydroxy-aryloxy end groups. These are known (see, for example, U.S. Pat. No. 3,419,634) or may be prepared by processes known in the literature. The preparation of copolycarbonates containing polydiorganosiloxanes is described, for example, in DE-OS 33 34 782.

Also suitable are polyester carbonates and block copolyester carbonates, in particular as described in WO 2000/26275. Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid.

Polydiorganosiloxane-polycarbonate block copolymers are characterised in that they contain in the polymer chain on the one hand aromatic carbonate structural units (1) and on the other hand polydiorganosiloxanes containing aryloxy end groups (2).

Such polydiorganosiloxane-polycarbonate block copolymers are known, for example, from U.S. Pat. No. 3,189,662, U.S. Pat. No. 3,821,325 and U.S. Pat. No. 3,832,419.

Preferred polydiorganosiloxane-polycarbonate block copolymers are prepared by reacting polydiorganosiloxanes containing alpha,omega-bishydroxyaryloxy end groups together with other diphenols, optionally with the concomitant use of branching agents in the conventional amounts, for example according to the two-phase interfacial process (see in this respect H. Schnell, Chemistry and Physics of Polycarbonates Polymer Rev. Vol. IX, page 27 ff, Interscience Publishers New York 1964), the ratio of the bifunctional phenolic reactants being so chosen that the content according to the invention of aromatic carbonate structural units and diorganosiloxy units results therefrom.

Such polydiorganosiloxanes containing alpha,omega-bishydroxyaryloxy end groups are known, for example, from U.S. Pat. No. 3,419,634.

The preferred acrylate-based polymeric particles having core-shell morphology that are to be used in accordance with the invention are, for example and preferably, those as disclosed in EP-A 634 445 (CA2127894 incorporated herein by reference).

The polymeric particles preferably have a core of a rubber-like vinyl polymer. The rubber-like vinyl polymer may be a homo- or co-polymer of any desired monomer that possesses at least one ethylene-like unsaturated group and is known to the person skilled in the field to enter into addition polymerization under the conditions of emulsion polymerization in an aqueous medium. Such monomers are listed in U.S. Pat. No. 4,226,752 incorporated herein by reference, Most preferably, the polymeric particles contain a core of rubber-like alkyl acrylate polymer, wherein the alkyl group has from 2 to 8 carbon atoms, optionally copolymerized with from 0 to 5% crosslinker and from 0 to 5% graft crosslinker, based on the total weight of the core. The rubber-like alkyl acrylate has preferably been copolymerized with up to 50% of one or more copolymerizable vinyl monomers, for example those mentioned above. Suitable crosslinking and graft-crosslinking monomers are well known to the person skilled in the field, and they are preferably those as described in EP-A 0 269 324.

The preferred core/shell particles entailed in the inventive composition are characterized in that the refractive index of the core and of the one or more jackets (shell) are preferably within +/−0.25 unit, more preferably within +/−0.18 unit, most preferably within +/−0.12 unit, of the refractive index of the polymeric resin in which the particles are distributed. The refractive indices of the core and shell/shells are preferably not closer than +/−0.003 unit, more preferably not closer than +/−0.01 unit, most preferably not closer than +/−0.05 unit, to the refractive index of the polymeric resin. The refractive index is measured in accordance with standard ASTM D 542-50 and/or DIN 53 400.

The polymeric particles generally have an average particle diameter of at least 0.5 micrometre, preferably from at least 1 micrometre to not more than 100 μm, more preferably from 2 to 50 micrometres, most preferably from 2 to 15 micrometres. The expression “average particle diameter” is to be understood as meaning the number average. Preferably at least 90%, most preferably at least 95%, of the polymeric particles have a diameter of more than 2 micrometres. The polymeric particles are a free-flowing powder, preferably in compacted form (pressed to give pellets, also to prevent dusting).

The polymeric particles may be prepared in a known manner. In general, at least one monomer component of the core polymer is subjected to emulsion polymerisation with the formation of emulsion polymer particles. The emulsion polymer particles are swelled with the same or with one or more different monomer components of the core polymer, and the monomer/monomers is/are polymeried within the emulsion polymer particles. The steps of swelling and polymerization may be repeated until the particles have grown to the desired core size. The core polymer particles are suspended in a second aqueous monomer emulsion, and a polymer jacket of the monomer/monomers is polymerised onto the polymer particles in the second emulsion. One jacket or a plurality of jackets may be polymeried onto the core polymer. The preparation of core/jacket polymer particles is described in EP-A 0 269 324 (corresponding to U.S. Pat. No. 5,346,954 ) and in U.S. Pat. Nos. 3,793,402 and 3,808,180 all incorporated herein by reference.

In an additional embodiment of the invention the composition additionally contains 0.001 to 0.2 wt. %, preferably 1000 ppm, of an optical brightener of the class of the bis-benzoxazoles, phenylcoumarins or bis-styrylbiphenyls.

A particularly preferred optical brightener is Uvitex OB from Ciba Spezialitätenchemie.

The plastics compositions according to the invention may be prepared by extrusion.

For extrusion, polycarbonate granules are fed to the extruder and melted in the plasticising system of the extruder. The plastics melt is pressed through a sheet die and thereby shaped, is brought into the desired final form in the roll slit of a friction calender, and its shape is fixed by alternate cooling on smoothing rollers and in the ambient air. The polycarbonates having high melt viscosity that are used for the extrusion are conventionally processed at melting temperatures of 260 to 320° C., and the cylinder temperatures of the plasticizing cylinder and the die temperatures are adjusted accordingly.

The rubber rollers used for structuring the film surface are disclosed in DE 32 28 002 (or the US equivalent 4,368,240).

By using one or more lateral extruders and suitable melt adaptors upstream of the sheet die it is possible to place polycarbonate melts having different compositions above one another and accordingly coextrude films (see, for example, EP-A 0 110 221 and EP-A 0 110 238).

Both the base layer of the molded laminate according to the invention and the coextruded layer(s) which is/are optionally present may additionally comprise additives, such as, for example, UV absorbers and other conventional processing aids, in particular mold release agents and flow agents, as well as the stabilizers conventional for polycarbonates, in particular heat stabilizers, as well as antistatics, optical brighteners. Different additives or concentrations of additives may be present in each layer.

In a preferred embodiment, the composition of the film additionally comprises from 0.01 to 5 wt. % of a UV absorber from the class of the benzotriazole derivatives, dimeric benzotriazole derivatives, triazine derivatives, dimeric triazine derivatives, diaryl cyanoacrylates.

In particular, the coextruded layer may comprise antistatics, UV absorbers and mold release agents.

Suitable stabilizers are, for example, phosphines, phosphites or Si-containing stabilizers and further compounds described in EP-A 0 500 496. Examples which may be mentioned include triphenyl phosphites, diphenylalkyl phosphites, phenyldialkyl phosphites, tris-(nonylphenyl) phosphite, tetrakis-(2,4-di-tert.-butylphenyl)-4,4′-biphenylene diphosphonite, bis(2,4-dicumyl-phenyl)pentaerythritol diphosphite and triaryl phosphite. Triphenylphosphine and tris-(2,4-di-tert.-butylphenyl) phosphite are particularly preferred.

Suitable mold release agents are, for example, the esters or partial esters of mono-to hexa-hydric alcohols, in particular of glycerol, of pentaerythritol or of guerbet alcohols.

Examples of monohydric alcohols are stearyl alcohol, palmityl alcohol and guerbet alcohols, an example of a dihydric alcohol is glycol, an example of a trihydric alcohol is glycerol, examples of tetrahydric alcohols are pentaerythritol and mesoerythritol, examples of pentahydric alcohols are arabitol, ribitol and xylitol, and examples of hexahydric alcohols are mannitol, glucitol (sorbitol) and dulcitol.

The esters are preferably the monoesters, diesters, triesters, tetraesters, pentaesters and hexaesters or mixtures thereof, in particular random mixtures, of saturated, aliphatic C₁₀- to C₃₆-monocarboxylic acids and optionally hydroxy-mono-carboxylic acids, preferably with saturated, aliphatic C₁₄- to C₃₂-monocarboxylic acids and optionally hydroxy-monocarboxylic acids.

The commercially available fatty acid esters, in particular of pentaerythritol and of glycerol, may contain <60% different partial esters, owing to their preparation.

Saturated, aliphatic monocarboxylic acids having from 10 to 36 carbon atoms are, for example, capric acid, lauric acid, myristic acid, palmitic acid, stearic acid, hydroxystearic acid, arachic acid, behenic acid, lignoceric acid, cerotic acid and montanic acids.

Examples of suitable antistatics are cationic compounds, for example quaternary ammonium, phosphonium or sulfonium salts, anionic compounds, for example alkylsulfonates, alkyl sulfates, alkyl phosphates, carboxylates in the form of alkali or alkaline earth metal salts, non-ionic compounds, for example polyethylene. glycol esters, polyethylene glycol ethers, fatty acid esters, ethoxylated fatty amines. Preferred antistatics are non-ionic compounds.

The plastics compositions according to the invention may be processed to polycarbonate films having a thickness of from 35 μm to 1000 μm. Depending on the field of application, they may also be thicker. The films may also be multi-layer composites of at least two solid molded bodies, for example films, which have been prepared by extrusion. In this case, the films according to the invention are composed of at least two polymer layers.

For the production of films by extrusion, the polycarbonate granules are fed to the extruder, from where they pass into the plasticizing system, which consists of a screw and a cylinder.

In the plasticizing system, the material is fed and melted. The plastics melt is pressed through a sheet die. Between the plasticising system and the sheet die there may be arranged a filtering device, a melt pump, stationary mixing elements and further components. The melt leaving the die passes onto a friction calender. A rubber roller was used for structuring one side of the film surface. Final shaping takes place in the roll slit of the friction calender. The rubber rollers used for structuring the film surface are disclosed in DE 32 28 002 (or the US equivalent 4,368,240). Finally, the shape is fixed by cooling, specifically by alternate cooling on the smoothing rollers and in the ambient air. The further devices serve for transportation, application of protective film and winding of the extruded films.

The Examples which follow are intended to illustrate the invention without limiting it.

### EXAMPLES

### Example 1

Compounding:

Preparation of the light-scattering compound using conventional twin-screw compounding extruders (e.g. ZSK 32) at processing temperatures conventional for polycarbonate of from 250 to 330° C.

A masterbatch having the following composition was prepared:
Makrolon 3108 550115 polycarbonate from Bayer MaterialScience AG in an amount of 80 wt. % and
core-shell particles having a butadiene/styrene core and a methyl methacrylate shell (Paraloid EXL 5137 from Rohm & Haas) having a particle size of 2 to 15 μm and a mean particle size of 8 μm, in an amount of 20 wt. %.
   Extrusion of films:

The device used consists of
an extruder having a screw with a diameter (D) of 75 mm and a length of 33×D. The screw has a degassing zone;
a melt pump;
a deflection head;
a sheet die having a width of 450 mm;
a three-roller friction calender with horizontal roller arrangement, the third roller being pivotable through +/−45° relative to the horizontal;
a roller conveyor;
thickness measurement;
a device for applying protective film to both sides;
a take-off device;
winding station.

The melt passes from the die to the friction calender, the rollers of which have the temperature indicated in Table 1. The third roller is a rubber roller for structuring the film surface. For structuring the film surface on one side, a rubber roller was used. The rubber rollers used for structuring the film surface are disclosed in DE 32 28 002 (or the US equivalent 4,368,240). Final shaping and cooling of the material takes place on the friction calender. The film is then transported by a take-off device, the protective film is applied to both sides, and the film is subsequently wound.

TABLE 1

| | Compound from example | |
|---|---|---|
| | Makrolon ® 3108 550115/20 | |
| | wt. % masterbatch | |
| Process parameter | from Example 1 | |
| Temperature extruder Z1 | 220° | C. |
| Temperature extruder Z2 | 280° | C. |
| Temperature extruder Z3 | 280° | C. |
| Temperature extruder Z4 | 280° | C. |
| Temperature extruder Z5 | 280° | C. |
| Temperature extruder Z6 | 280° | C. |
| Temperature deflection head | 280° | C. |
| Temperature die/lateral plate | 280° | C. |
| Temperature die Z13 | 280° | C. |
| Temperature die Z14 | 280° | C. |
| Temperature die Z15 | 280° | C. |
| Temperature die/lateral plate | 280° | C. |
| Temperature die Z17 | 280° | C. |
| Temperature die Z18 | 280° | C. |
| Temperature die Z19 | 280° | C. |
| Extruder speed | 60 | min⁻¹ |
| Melt pump speed | 44 | min⁻¹ |
| Temperature roller 1 (rubber roller) | 40° | C. |
| Temperature roller 2 | 100° | C. |
| Temperature, roller 3 | 130° | C. |
| Calender speed | 13.8 | m/min |
| Throughput | 38 | kg/h |

| | |
|---|---|
| Film width/thickness | 385 mm/100 μm |

### Example 2

A compound having the following composition was mixed:

Makrolon 3108 550115 polycarbonate in an amount of 96 wt.-% and
masterbatch according to Example 1 in an amount of 4 wt.-%.

A 300 μm film structured on one side and comprising 0.8 wt.-% scattering additive was extruded therefrom.

### Example 3

A compound having the following composition was mixed:

Makrolon 3108 550115 polycarbonate in an amount of 94 wt. % and
masterbatch according to Example 1 in an amount of 6 wt. %.

A 300 μm film structured on one side and comprising 1.2 wt. % scattering additive was extruded therefrom.

### Example 4

Compounding:

Preparation of the light-scattering masterbatch using conventional twin-screw compounding extruders (e.g. ZSK 32) at processing temperatures conventional for polycarbonate of from 250 to 330° C.

A masterbatch having the following composition was prepared:

Makrolon 3108 550115 polycarbonatein an amount of 80 wt. % and
acrylate scattering particles MBX-5 from Sekisui having a particle size of from 2 to 15 μm and a mean particle size of 5 μm, in an amount of 20 wt. %.
   Extrusion of Films:

The compound is used to extrude 300 μm thick polycarbonate films having a width of 1340 mm.

The device used consists of
an extruder having a screw with a diameter (D) of 105 mm and a length of 41×D. The screw has a degassing zone;
a deflection head;
a sheet die having a width of 1500 mm;
a three-roller friction calender with horizontal roller arrangement, the third roller being pivotable through +/−45° relative to the horizontal;
a roller conveyor;
a device for applying protective film to both sides;
a take-off device;
winding station.

The melt passes from the die to the friction calender, the rollers of which have the temperature indicated in Table 1. Final shaping and cooling of the material take place on the smoothing calender. For structuring the film surface on one side, a rubber roller was used. The rubber rollers used for structuring the film surface are disclosed in DE 32 28 002 (or the US equivalent 4 368 240). The film is then transported by a take-off device, the protective film is applied to both sides, and the film is subsequently wound.

TABLE 2

| | Compound from example | |
|---|---|---|
| | (Makrolon ® 3108/5 | |
| | wt. % masterbatch | |
| Process parameter | according to Example 4) | |
| Temperature extruder Z1 | 250° | C. |
| Temperature extruder Z2 | 250° | C. |
| Temperature extruder Z3 | 250° | C. |
| Temperature extruder Z4 | 250° | C. |
| Temperature extruder Z5 | 250° | C. |
| Temperature extruder Z6 | 250° | C. |
| Temperature extruder Z7 | 250° | C. |
| Temperature extruder Z8 | 260° | C. |
| Temperature extruder Z9 | 270° | C. |
| Temperature deflection head | 300° | C. |
| Temperature die Z1 | 310° | C. |
| Temperature die Z2 | 305° | C. |
| Temperature die Z3 | 305° | C. |
| Temperature die Z4 | 305° | C. |
| Temperature die Z5 | 305° | C. |
| Temperature die Z6 | 305° | C. |
| Temperature die Z7 | 310° | C. |
| Temperature die Z8 | 310° | C. |
| Temperature die Z9 | 305° | C. |
| Temperature die Z10 | 305° | C. |
| Temperature die Z11 | 305° | C. |
| Temperature die Z12 | 305° | C. |
| Temperature die Z13 | 305° | C. |
| Temperature die Z14 | 310° | C. |
| extruder speed | 60 | min⁻¹ |
| Temperature roller 1 (rubber roller) | 82° | C. |
| Temperature roller 2 | 87° | C. |
| Temperature roller 3 | 138° | C. |
| Calender speed | 8 | m/min. |

| | |
|---|---|
| Film width/thickness | 1340 mm/300 μm |

### Example 5

A compound having the following composition was mixed:

Makrolon 3108 550115 polycarbonate in an amount of 95 wt.-% and
masterbatch according to Example 4 in an amount of 5 wt.-%.

A 300 μm film structured on one side and comprising 1.2 wt.-% scattering additive was extruded therefrom.

### Example 6

A compound having the following composition was mixed:

Makrolon 3108 550115 polycarbonate in an amount of 50 wt. % and
masterbatch according to Example 4 comprising Techpolymer MBX-5 from Sekisui having a particle size of from 2 to 15 μm and a mean particle size of 5 μm, in an amount of 50 wt. %.

A 300 μm film structured on one side and comprising 10.0 wt. % scattering additive was extruded therefrom.

### Example 7

AFM Investigations

Extruded films comprising Paraloid 5137 EXL or Techpolymer MBX-5 were prepared and their properties determined.

AFM investigations were carried out on the extruded films of Examples 2 and 3 and 5 and 6. The number and size of the nano-scale particles were determined on three preparations at three locations, and the mean was calculated . The results are summarized in the- following Table.

TABLE 3

| | Average number of | |
|---|---|---|
| | nano-scale particles | Conc. of nano- |
| | having a size of from | scale particles |
| Example | 80 to 200 nm/10 × 10 μm² | [ppm] |
| Example 2 | 6 | approximately 30 |
| Example 3 | 9 | approximately 50 |
| Example 5 | 3 | approximately 10 |
| Example 6 | 1 | approximately 2 |

Optical Measurements

The films described in Examples 3 and 5 were tested for their optical properties in accordance with the following standards and using the following measuring devices:

To determine the light transmission (Ty (C2°)), an Ultra Scan XE from Hunter Associates Laboratory, Inc. was used. For the light reflection (Ry (C2°)), a Lambda 900 from Perkin Elmer Optoelectronics was used. For the haze determination (in accordance with ASTM D 1003), a Hazegard Plus from Byk-Gardner was used. The half-width angle HW as a measure of the strength of the light-scattering action was determined using a goniophotometer in accordance with DIN 58161. The luminance measurements (brightness measurements) were carried out on a backlight unit (BLU) from DS LCD (LTA320W2-L02, 32″ LCD TV panel) with the aid of a LS100 luminance meter from Minolta. The original diffuser sheet was removed and replaced by the films produced in Examples 3 and 5.

Optical Measurement Results

TABLE 4

| | Example 3 | Example 5 |
|---|---|---|
| Light Transmission [%] | 85.5 | 87.02 |
| Light Reflection [%] | 10.6 | 10.42 |
| Haze [%] | 90.7 | 93 |
| Half-width angle [°] | 8.5 | 6.8 |
| Brightness [cd/m²] without films | 6148 | 6078 |
| Brightness [cd/m²] with films | 7065 | 7354 |

In the two Examples 3 and 5 listed in Table 4, the content of scattering pigments and the light-scattering layer are the same and the layer thickness is 300 μm. The base material used is also the same. It is surprising that the diffuser films from Example 5 exhibit the highest luminance in the BLU.

The investigated brightness is striking on comparison. The procedure was as follows for measurement of the brightness: specimens were cut out of the films of Examples 3 and 5 to fit into a backlight unit (BLU) from DS LCD (LTA320W2-L02, 32″ LCD TV panel) and installed therein. For this, the film which lies directly on the diffuser sheet of the backlight unit was replaced by the exemplified films. These films were arranged such that the smooth side was laid on the diffuser sheet. The other two films (Dual Brightness Enhancement Film [DBEF] and Brightness Enhancement Film [BEF] which were on the replaced film in the backlight unit were laid back on the films from the examples in the original sequence and arrangement after the replacement. Accordingly, the sequence of films in the BTU was as follows:
BEF
DBEF
Exemplified film
Diffuser Sheet

The brightness of the backlight unit modified in this way was measured.

The brightness was then determined with and without the set of films used in this backlight unit. The brightness at a total of 9 different locations on the backlight unit was measured (using Minolta LS100 luminance meter) and the mean was calculated therefrom.

The Examples show that the brightness correlates with the number of nano-scale particles. The fewer such particles are present, the greater the brightness.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic composition comprising 90 to 99.95 percent of a transparent first polymeric resin and 0.01 to 10 percent particles of transparent second polymeric resin said particles having a mean particle diameter of 1 to 100 μm and refractive index different from that of the first polymeric resin, not more than 500 ppm of said particles having particle diameter in the range of 80 to 200 nm, said percent, both occurrences being relative to the weight of the composition.

2. The composition according to claim 1, wherein said first polymeric resin is polycarbonate.

3. A film comprising the composition according to claim 1.

4. A multilayered film laminate comprising the film of claim 3 and at least one coextruded layer.

5. The composition of claim 1 wherein said particles are acrylate-based particles having core-shell morphology.

6. The film according to claim 3 having thickness of 0.035 to 1 mm.

7. A diffuser film comprising the composition of claim 1.

8. A backlight-unit comprising the film of claim 7.

9. A flat screen comprising the film of claim 7 or the backlight-unit of claim 8.
